(19) United States
(12) Patent Application Publication
(10) Pub. No.: US 2012/0317954 A1
(43) Pub. Date: Dec. 20, 2012

(54) Glove rake

(76) Inventors: John J. Landicini, JR., Vineland, NJ (US); Victoria M. Landicini, Vineland, NJ (US)

(21) Appl. No.: 13/134,725

(22) Filed: Jun. 15, 2011

(51) Int. Cl. A01D 7/00

(52) U.S. Cl. 56/400.01

(57) ABSTRACT

A glove rake having a palm section, a knuckle section, and finger elements extending from the knuckle section. Each finger element is independently secured to a rake element having a lower section into which the finger element is positioned and an elongated rake section rigidly secured and extending from the lower section. Each finger element is permanently attached to its respective rake element by a sleeve member which encompasses and covers both the finger section and the entire lower section of the rake element. The sleeve member and rake element are secured to finger elements above the knuckle section of the glove rake in order to allow the wearer to independently and separately move and rotate each finger element. The finger elements can be moved either one at a time, in tandem, or together to accomplish a variety of gardening, landscaping, and yard work tasks.

### BACKGROUND OF THE INVENTION

Various manual tools are utilized in doing gardening, landscaping and other outdoor yard work. Often times, certain tools may be too large, bulky, or otherwise difficult to use or manipulate for particular tasks. In such cases, the gardener, landscaper, or yard worker is left to do the work, e.g. digging, raking, gathering, cleaning, etc. with his or her hands and fingers. Even with normal work gloves, this becomes quite difficult and is generally very inefficient.

To address this situation, a number of “glove tools” have been developed. Such glove tools usually combine gardening gloves with various modified rakes, shovels, spades, or other gardening tool features. However, these prior glove tools are, in most cases, cumbersome and inefficient in use, since they restrict the movement and free activity of the wearer. Many also have limited utility and versatility and are actually more of a hindrance than a help in assisting the wearer with gardening and yard work.

### SUMMARY OF THE INVENTION

It is thus the object of the present invention to provide a glove rake which overcomes the limitations and disadvantages of existing glove tools.

It is the object of the present invention to provide a glove rake which truly acts as an extension of the wearer's hand, allowing the wearer to separately and independently rotate each of the fingers of the glove rake to perform a variety of different gardening, landscaping, and yard work tasks with maximum efficiency.

These and other objects are accomplished by the present invention, a glove rake which comprises a palm section, a knuckle section, and finger elements extending from the knuckle section. Each finger element is independently secured to a rake element having a lower section into which the finger element is positioned and an elongated rake section rigidly secured and extending from the lower section. Each finger element is permanently attached to its respective rake element by a sleeve member which encompasses and covers both the finger section and the entire lower section of the rake element. The sleeve member and rake element are secured to finger elements above the knuckle section of the glove rake in order to allow the wearer to independently and separately move and rotate each finger element. The finger elements can be moved either one at a time, in tandem, or together to accomplish a variety of gardening, landscaping, and yard work tasks.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a top perspective view of the right hand glove rake of the present invention.

FIG. 2 is a bottom perspective view of the right hand glove rake of the present invention.

FIG. 3 is a top perspective view, showing individual components of the right hand glove rake of the present invention.

FIG. 4 is a view showing the manner of rotation of the right hand glove rake of the present invention.

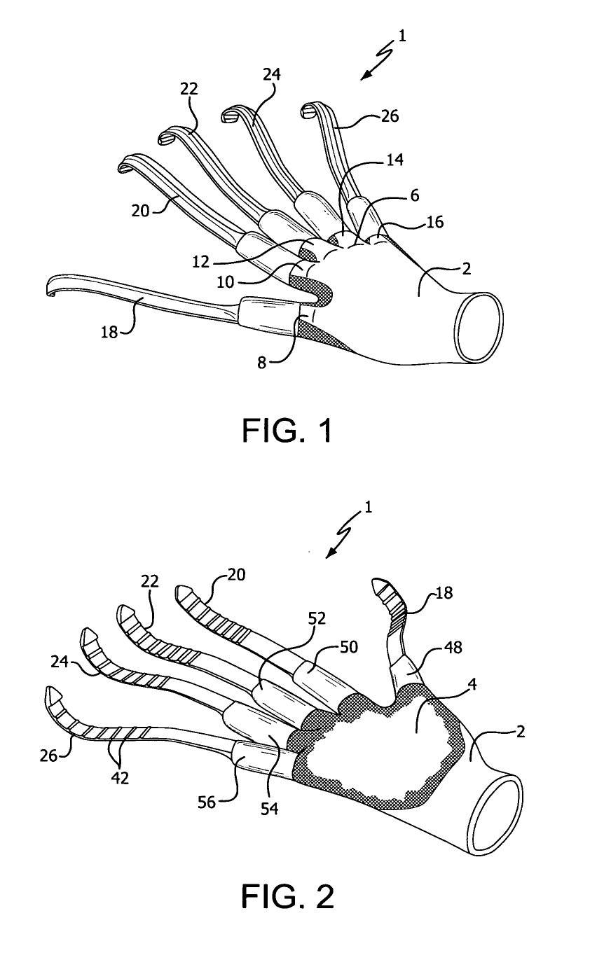

### DETAILED DESCRIPTION OF THE INVENTION

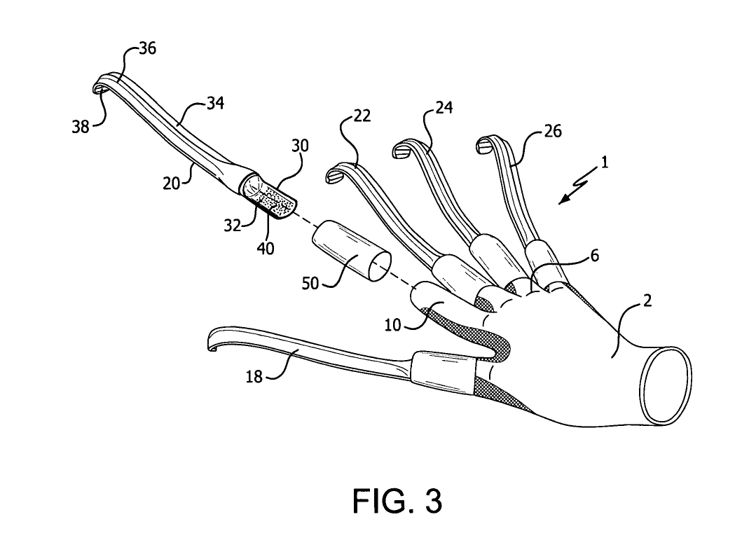

Glove rake 1 comprises standard-type gardening or work glove 2 having palm section 4, knuckle section 6, and finger elements 8, 10, 12, 14, and 16. These finger elements extend the full finger lengths of the standard glove from the knuckle section to the end of the finger element, in order to fully accommodate the fingers of a wearer, e.g. see FIG. 3 and finger element 10. Rake elements 18, 20, 22, 24, and 26 are secured to each finger element. The rake elements are substantially identical in configuration. Representative rake element 20, shown separated from its finger element 10 in FIG. 3, comprises lower rake section 30 having recess opening 32, and elongated rake section 34 rigidly secured to and extending from the lower section. Rake section 34 itself comprises arm section 36 which merges into curved leaf and debris gathering end 38. Upstanding ridges 42 on each rake element enhance their functionality.

Finger elements 8, 10, 12, 14, and 16 are each permanently secured to their respective rake elements 18, 20, 22, 24, and 26. FIG. 3, again with reference to representative rake element 20, shows the connection between finger element 10 and rake element 20. Finger element 10 is first positioned within recess opening 32 of lower section 30 of rake element 20 and is attached thereto by high strength adhesive 40. Sleeve member 50 is then positioned over and around finger element 10 and lower section 30, such that the sleeve member encompasses both the finger element and the entire lower section. Sleeve member 50 is then pressure fitted in this position to securely maintain the connection between finger element 10 and rake element 20, to form a unitary finger element/rake element unit.

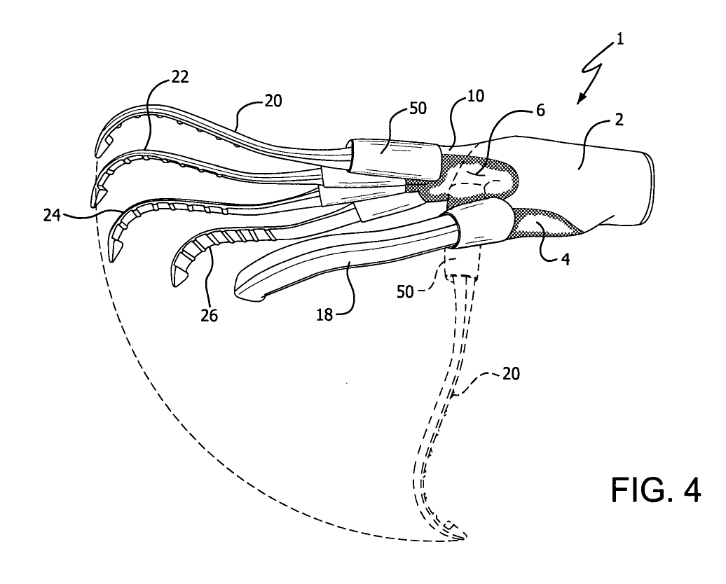

It is important to note that sleeve member 50, and all other sleeve members 48, 52, 54, and 56, are permanently secured around their respective finger elements and attached rake elements above knuckle section 6. By this configuration, when glove rake 1 is worn by the user, each finger element/rake element unit is separately and independently moveable and rotatable about knuckle section 6, when the wearer bends his or her hand. See FIG. 4. Glove rake 1 actually becomes an extension of the wearer's hand. The wearer can move his or her fingers normally within glove 2, and has the added advantage of extended “fingers”, making glove rake 1 a most valuable tool in doing gardening, landscaping, and yard work.

In use, the wearer simply inserts his or her hand into glove 2 of glove rake 1. The normal, standard length of finger elements 8, 10, 12, 14, and 16 ensures that the full hand, including the fingers of the wearer, can comfortably be positioned within glove rake 1. Since each finger element/finger rake unit is separately and independently rotatable, e.g. as seen in FIG. 4 showing the independent rotation of finger element 10 and its rake element 20, the wearer is free to move and rotate only one of the finger elements/finger rake units, rotate two or more of the units in tandem, or move all five units to do a variety of tasks.

Aside from the obvious function of gathering leaves and other debris, glove rake 1 can be used for such diverse tasks as cleaning leaves from bushes, clearing house gutters, digging shallow trenches, aerating soil, and weeding gardens. Glove rake 1 is a most versatile outdoor tool which will allow the wearer to be more efficient in his or her garden or yard.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A glove rake for the hands of a wearer comprising:
a glove with a palm section, a knuckle section, and five finger elements extending from the knuckle section, each finger element extending the full length of the fingers on the hand of a wearer from the knuckle section to the end of the finger element;
a separate rake element secured to each finger element, each said rake element comprising a lower section having a recess opening of finite length, each finger element is being positioned within the entire length of an opening, and an elongated rake section rigidly secured to and extending from the lower section of each rake element; and
sleeve means for connecting the lower section of each of the rake elements to their respective finger elements, said sleeve means terminating at a location above the knuckle section, the sleeve means fully encircling and entirely covering each lower section and its respective opening and finger element located within the opening, whereby when the wearer's hand is positioned within the glove, each finger element and its respective rake element is separately and independently moveable and rotatable about the knuckle section or two or more finger elements and their respective rake elements are moveable and rotatable in tandem about the knuckle section.

2. The glove rake as in claim 1 wherein each elongated rake element is longer than any of the finger elements.

3. The glove rake as in claim 1 wherein each rake element comprises an arm section merging into a curved end section.

4. The glove rake as in claim 1 wherein the sleeve means comprises separate sleeve members, each encompassing and covering one finger element and the entire lower section of the rake element in which the finger element is positioned.

5. The glove rake as in claim 4 wherein each rake element is connected to the glove solely by a sleeve member.

6. The glove rake as in claim 1 wherein each rake element comprises upstanding ridges.
